(19) United States
(12) Patent Application Publication
(10) Pub. No.: US 2002/0079156 A1
(43) Pub. Date: Jun. 27, 2002

(54) Hall effect torque sensor

(76) Inventor: Andrew Kurt Nazars, Redford, MI (US)

Correspondence Address: BRINKS HOFER GILSON & LIONE, P.O. BOX 10395, CHICAGO, IL, 60610, US

(21) Appl. No.: 09/748,676

(22) Filed: Dec. 22, 2000

(51) Int. Cl. B62D 5/04

(52) U.S. Cl. 180/442

(57) ABSTRACT

A vehicle power steering system for providing steering assistance to a vehicle operator to control rotation of a vehicle's road wheels is disclosed. The system includes a steering wheel, a torque converter, an annular magnet, a transducer, a motor, and a controller. The steering wheel has an input shaft for receiving and transmitting a rotational force from the vehicle operator. The torque converter includes a translator and a torsion bar, the torsion bar is connected to the input shaft and twists in response to the rotational force applied to the steering wheel, the translator is coupled to the torsion bar and moves axially in response to twisting of the torsion bar. The annular magnet is fixedly secured to the translator and generates a magnetic field. The transducer is located proximate to the magnet for generating an output signal indicative of a change in the magnet field. The motor has a motor output, wherein the motor output is in communication with a steering rack for rotating the vehicle's road wheels. The controller is in communication with the transducer and the motor, wherein the controller correlates a change in the magnetic field with the torque applied to the input shaft to control the motor output for assisting the vehicle operator in steering the vehicle.

### TECHNICAL FIELD OF THE INVENTION

The present invention generally relates to devices for measuring torque in a rotating shaft.

### BACKGROUND

The need to measure the amount of torque in a rotating shaft is quite prevalent throughout the automotive industry, as well as in other industries. It is well known in the art to use variable reluctance sensors, variable resistance sensors, potentiometers, and linear velocity displacement transducers (LVDT) coupled to a torque converter, such as the torque converter disclosed in United States Patent # which is expressly incorporated herein by reference, to measure torque in a shaft. Other torque measuring devices utilize hall effect sensors and magnets to measure torque in a torsion bar.

Unfortunately, while the prior art devices accomplish their intended purpose improvements are still needed. A new and improved device for measuring torque in a rotating shaft must contain a minimal number of components while providing an accurate measurement of the torque present in a shaft. Additionally, unlike prior art devices the new and improved device must be operable with a torque converter that is free to rotate. Finally, the new and improved device for measuring torque must provide an output signal that is unaffected by environmental changes, such as changes in temperature and humidity.

### SUMMARY OF THE INVENTION

In accordance with an aspect of the present invention, a vehicle power steering system for providing steering assistance to a vehicle operator to control rotation of a vehicle's road wheels is provided. The system includes a steering wheel, a torque converter, an annular magnet, a transducer, a motor, and a controller.

The steering wheel has an input shaft for receiving and transmitting a rotational force from the vehicle operator. The torque converter includes a translator and a torsion bar, the torsion bar is connected to the input shaft and twists in response to the rotational force applied to the steering wheel, the translator is coupled to the torsion bar and moves axially in response to twisting of the torsion bar. The annular magnet is fixedly secured to the translator and generates a magnetic field. The transducer is located proximate to the magnet for generating an output signal indicative of a change in the magnet field. The motor has a motor output, wherein the motor output is in communication with a steering rack for rotating the vehicle's road wheels. The controller is in communication with the transducer and the motor, wherein the controller correlates a change in the magnetic field with the torque applied to the input shaft to control the motor output for assisting the vehicle operator in steering the vehicle.

In accordance with another aspect of the invention the magnet is preferably a rare earth magnet.

In accordance with another aspect of the invention the transducer is preferably a Hall effect sensor.

In accordance with still another aspect of the invention a secondary transducer is provided for supplying a redundant signal output.

In accordance with yet another aspect of the invention a system for measuring torque in a rotatable shaft is provided. The system has an input shaft, a torque converter, an annular magnet, and a transducer.

The input shaft is for receiving and transmitting a rotational force. The torque converter has a translator and a torsion bar, the torsion bar is connected to the input shaft and twists in response to the rotational force, the translator is coupled to the torsion bar and moves axially in response to twisting of the torsion bar. The annular magnet is fixedly secured to the translator for generating a magnetic field. The transducer is located proximate to the annular magnet for generating an output signal indicative of a change in the magnet field produced by axial movement of the magnet.

In accordance with still another aspect of the invention a device for measuring torque in a rotatable shaft is provided. The device is coupled to a torque converter having a translator and a torsion bar, the torsion bar is connected to the rotatable shaft and twists in response to a torque applied to the rotatable shaft. The translator is coupled to the torsion bar and moves axially in response to twisting of the torsion bar. The device includes an annular magnet and a sensing element. The annular magnet is fixedly secured to the translator for generating a magnetic field. The sensing element is located proximate to the annular magnet for generating an output signal indicative of a change in the magnet field produced by axial movement of the magnet.

Further objects, features and advantages of the invention will become apparent from consideration of the following description and the appended claims when taken in connection with the accompanying drawings.

### BRIEF DESCRIPTION OF THE DRAWINGS

FIG. 1 is a schematic diagram of a vehicle steering system utilizing the torque sensor, in accordance with the present invention;

FIG. 2 is a top cutaway view of a torque sensor showing a first position of sensed element with respect to a sensing element, in accordance with the present invention; and

FIG. 3 is a top cutaway view of a torque sensor showing the sensed elements in a second position relative to the sensing element, in accordance with the present invention.

### DETAILED DESCRIPTION OF THE PREFERRED EMBODIMENT

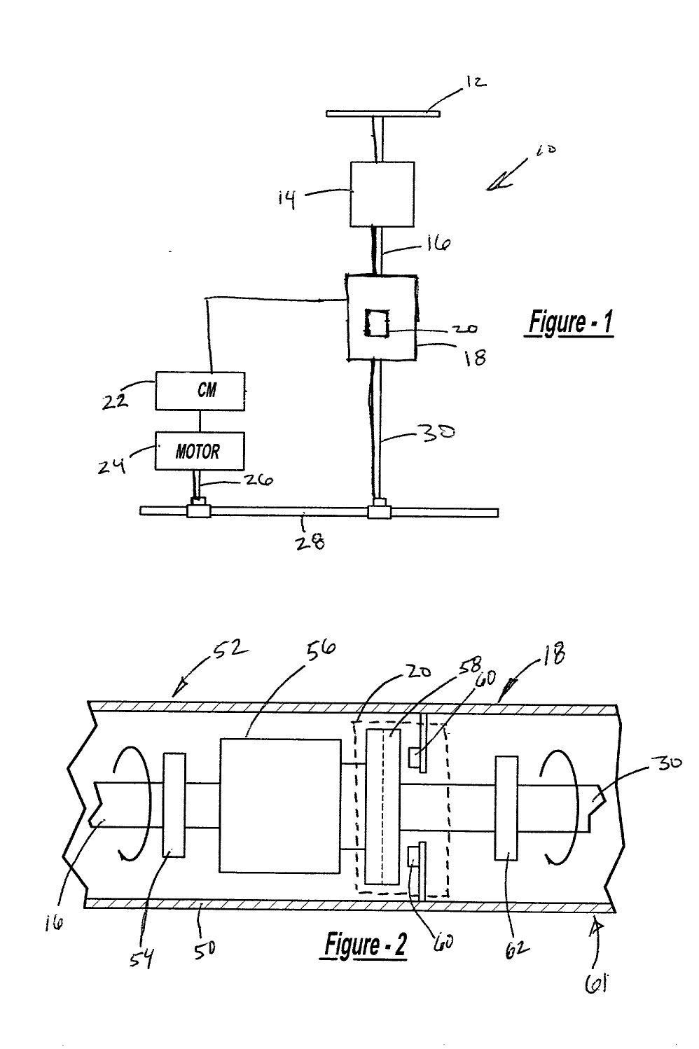

Shown in FIG. 1 is a vehicle steering system 10 for controlling the angular rotation of a vehicle's front wheels. Steering system 10 provides a vehicle operator with power assisted steering, as well as manual steering as will now be described in greater detail hereinafter.

Steering system 10 includes a steering wheel 12 that is operable by a vehicle operator, a steering column 14 that rotationally couples the steering wheel to an input transmission shaft 16, a torque converter 18 having a torque sensor 20 for measuring the torque applied by the vehicle operator through steering wheel 12, a steering controller module 22 in communication with torque sensor 20 for controlling a motor 24 and motor shaft 26 connecting a motor output to a steering rack 28. Additionally, an output transmission shaft 30 communicates the torque applied to steering wheel 12 by a vehicle operator through input transmission shaft 16 and torque converter 18 to rack 28. Output transmission shaft 30 allows manual steering back-up when the power assisted steering supplied by motor 24 is unavailable.

The physical connection of the motor output shaft to the rack 28 may be provided via a separate motor shaft 26 as shown or integrated into the output transmission shaft 30 or integrated into steering column 14. Motor 24 is preferably an electric motor that is supplied electrical power by the vehicle's electrical system (i.e. battery, alternator, etc.). The power assisted steering provided by controller module 22 and motor 24 replaces conventional hydraulic power assisted systems.

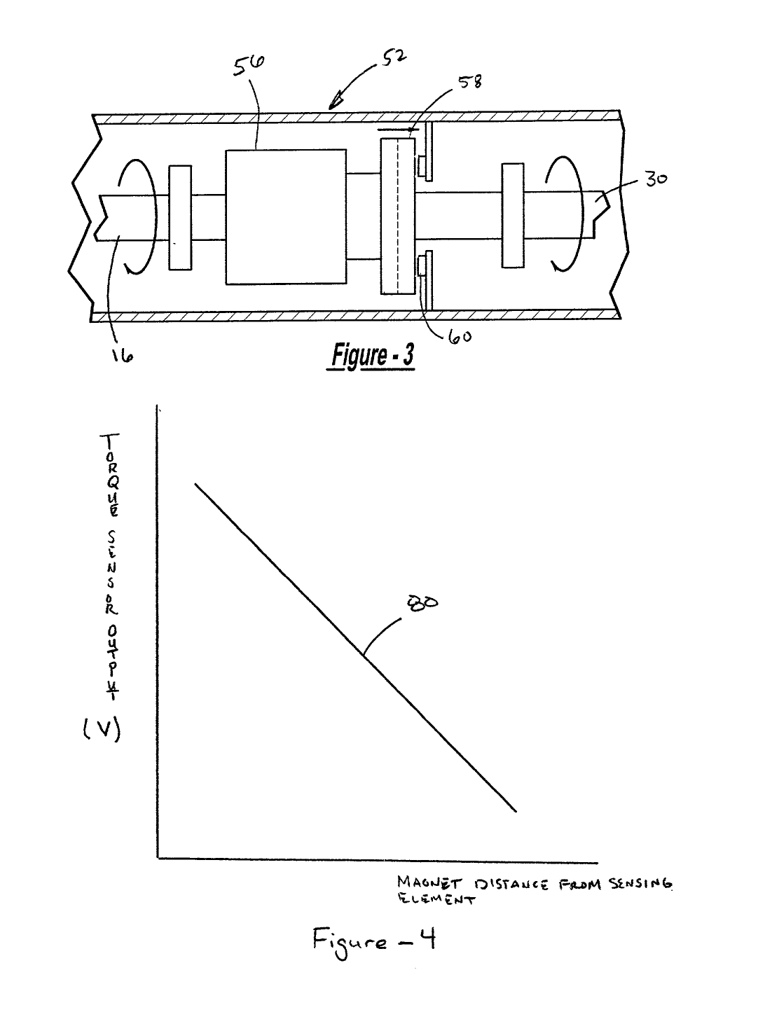

Referring now to FIG. 2, torque converter 18 is shown in greater detail, in accordance with the present invention. Torque converter 18 includes a housing 50 that receives input transmission shaft 16 at a first end 52. As is conventionally known, transmission shaft 16 is supported within housing 50 by a transmission shaft bearing assembly 54. Transmission shaft bearing assembly 54 supports input transmission shaft 16 and allows the shaft to freely rotate clockwise and counterclockwise as the steering wheel is rotated in a like manner.

Input transmission shaft 16 is coupled to torque converter 18 via a translator member 56. Translator 56 includes a torsion bar (not shown) for receiving a finite amount of torque from the input transmission shaft. The amount of torque developed in the torsion bar is governed by the rotational force created by the driver turning the steering wheel (transmitted through input transmission shaft 16) and the load created by the resistance to angular rotation of the front tires (communicated by output transmission shaft 30). As well known in the art, torque translator 56 converts

Translator 56 further includes a sensed element 58 that cooperates with sensing element 60. Sensed element 58 is fixed to translator 56 and moves axially with respect to input transmission shaft 16 when a torque is applied to the torsion bar. Depending on the direction of rotation of the steering wheel and thus the transmission shaft 16, sensed element 58 will move closer or further away from sensing element 60.

In a preferred embodiment, sensed element 58 is an annular magnet for generating a magnetic field that envelops sensing element 60. Magnets such as rare earth magnets having sufficient magnetic field strength are also preferable. The annular magnet must be rotationally tuned and produce a stable predictable magnetic field over the typical automotive temperature range (−35° F. to 200° F.). Sensing element 60 are preferably Hall effect sensors that are capable of detecting a change in magnetic flux caused by the change in proximity of the sensed element or magnet 58 with respect to the sensing element 60. An exemplary Hall effect sensor that is usable with the present invention is a Hall Effect sensor (AMR type) manufactured by Micronas Semiconductor AG, of Munich, Germany.

As shown torque converter 18 is coupled at a second end 61 to output transmission shaft 30. For safety considerations, output transmission shaft 30 operates on rack 28 to rotate the front wheels of the vehicle when the power assisted steering is unavailable. A secondary bearing assembly 62 supports output transmission shaft 30 and allows the shaft to freely rotate within housing 50.

With reference to FIGS. 2 and 3, the operation of the torque sensor 20 will be described, in accordance with the present invention. Annular magnet 58 is shown at a maximum distance relative to sensing element 60. This position of annular magnet 58 is reached when the steering wheel is rotated in one direction (such as clockwise) under such an angular force to create a maximum torque condition to develop in the torsion bar. Referring now to FIG. 3 torque sensor 20 is shown with the sensed element or magnet 58 at a closest position with respect to sensing element 60, in accordance with the present invention. This position of annular magnet 58 is reached when the steering wheel is rotated in the other direction (such as counter-clockwise) under such an angular force to create a maximum torque condition to develop in the torsion bar.

It is an important advantage of the present invention that sensing element 60 provide a torque output signal when the sensed element or magnet 58 is in a fully retracted position and in the closest position with respect to the sensing element 60. Thus, the present invention is able to determine the rotational direction in which the steering wheel is turned and the amount of torque applied from when the steering wheel is in a fully clockwise position through to a fully counter-clockwise position.

As shown in FIGS. 2 and 3 a secondary sensing element 64 is provided for redundancy only and is not required for operability of the instant invention.

With reference to FIG. 4 a typical torque sensor output signal 80 is illustrated, in accordance with the present invention. More specifically, FIG. 4 is graph of torque sensor output voltage versus the distance of the annular magnet 58 with respect to sensing element 60. As shown the torque sensor output voltage varies linearly with the distance the annular magnet 58 is from sensing element 60. When the annular magnet 58 is at the closest position to the sensing element 60 the torque sensor output voltage is at a maximum value, such as 5 or 10 volts. Conversely, when the annular magnet 58 is at its farthest position with respect to the sensing element 60 the torque sensor output voltage is at a minimum value, such as 0 or 1 volts.

The torque sensor output voltage is communicated to the steering controller module 22 where it is analyzed and processed, in accordance with the present invention. Steering controller module 22 determines the direction of the torque applied to the steering wheel and torque converter 18 and the level of the torque. Once this information is determined controller module 22 commands the motor to rotate shaft 26 with sufficient torque to rotate the vehicle's front tires by an amount desired by the vehicle's driver as dictated by the amount of rotational force the driver has applied to the steering wheel. As a result the present invention provides power assisted steering using an electric motor.

The foregoing discussion discloses and describes a preferred embodiment of the invention. One skilled in the art will readily recognize from such discussion, and from the accompanying drawings and claims, that changes and modifications can be made to the invention without departing from the true spirit and fair scope of the invention as defined in the following claims.

1. A vehicle power steering system for providing steering assistance to a vehicle operator to control rotation of a vehicle's road wheels, the system comprising:
a steering wheel having an input shaft for receiving and transmitting a rotational force from the vehicle operator;
a torque converter having a translator and a torsion bar, the torsion bar is connected to the input shaft and twists in response to the rotational force applied to the steering wheel, the translator is coupled to the torsion bar and moves axially in response to twisting of the torsion bar;
an annular magnet fixedly secured to the translator for generating a magnetic field;
a transducer located proximate to the magnet for generating an output signal indicative of a change in the magnet field produced by axial movement of the magnet;
a motor having a motor output, wherein the motor output is in communication with a steering rack for rotating the vehicle's road wheels; and
a controller in communication with the transducer and the motor for controlling the motor output to assist the vehicle operator in steering the vehicle.

2. The system of claim 1 wherein the magnet is a rare earth magnet.

3. The system of claim 1 wherein the transducer is a Hall effect sensor.

4. The system of claim 1 further comprising a secondary transducer for providing a redundant signal output.

5. A system for measuring torque in a rotatable shaft, the system comprising:
an input shaft for receiving and transmitting a rotational force;
a torque converter having a translator and a torsion bar, the torsion bar is connected to the input shaft and twists in response to the rotational force, the translator is coupled to the torsion bar and moves axially in response to twisting of the torsion bar;
an annular magnet fixedly secured to the translator for generating a magnetic field; and
a transducer located proximate to the annular magnet for generating an output signal indicative of a change in the magnet field produced by axial movement of the magnet.

6. The system of claim 5 wherein the annular magnet is a rare earth magnet.

7. The system of claim 5 wherein the transducer is a Hall effect sensor.

8. The system of claim 5 further comprising a secondary transducer for providing a redundant output signal.

9. A device for measuring torque in a rotatable shaft, the device is coupled to a torque converter having a translator and a torsion bar, the torsion bar is connected to the rotatable shaft and twists in response to a torque applied to the rotatable shaft, the translator is coupled to the torsion bar and moves axially in response to twisting of the torsion bar, the device comprising:
an annular magnet fixedly secured to the translator for generating a magnetic field; and
a sensing element located proximate to the annular magnet for generating an output signal indicative of a change in the magnet field produced by axial movement of the magnet.

10. The device of claim 9 wherein the magnet is a rare earth magnet.

11. The device of claim 9 wherein the sensing element is a Hall effect sensor.

12. The device of claim 9 further comprising a secondary sensing element for providing a redundant signal output.
